(19) United States
(12) Patent Application Publication
(10) Pub. No.: US 2006/0173689 A1
(43) Pub. Date: Aug. 3, 2006

(54) Speech information service system and terminal

(76) Inventors: Nobuo Hataoka, Shiroyama (JP); Ichiro Akahori, Anjou (JP); Masahiko Tateishi, Nagoya (JP); Teruko Mitamura, Pittsburgh, PA (US); Eric Nyberg, Pittsburgh, PA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/210,857

(22) Filed: Aug. 25, 2005

(30) Foreign Application Priority Data
Sep. 29, 2004 (JP) JP2004-284603

(51) Int. Cl. G10L 21/00

(52) U.S. Cl. 704/275

(57) ABSTRACT

An object of the present invention is to provide a user interface method and a device capable of arbitrarily and efficiently performing the dialog through the speech input in an in-vehicle information service system, and a system configuration which can cope with network connection loss with a center is also provided. In addition, the present invention provides the system configuration in which access from a terminal to the center is not always performed but can be performed arbitrarily according to needs. As a terminal-side configuration, a flexible dialog management unit and a task management unit for performing application management are separated from each other. Furthermore, the terminal configuration has a four-tier structure of a user interface, dialog management, task management, and applications. In addition, means for fetching application information from the center in accordance with needs is provided.

### CROSS-REFERENCE TO RELATED APPLICATION

The present application claims priority from Japanese Patent Application No. JP 2004-284603 filed on Sep. 29, 2004, the content of which is hereby incorporated by reference into this application.

### TECHNICAL FIELD OF THE INVENTION

The present invention relates to a device or software and an interface for providing means for efficiently sharing functions between a terminal and a center, in a network-type information service system using a terminal having a speech input/output function.

### BACKGROUND OF THE INVENTION

Since the various types of conventional information service systems utilizing speech, in particular, the car navigation system do not have the network-type configuration provided with a server, it cannot arbitrarily acquire the information of the center side. Alternatively, even if the system has the network-type configuration, a dialog sequence of the speech input is always uniform and the arbitrary speech input cannot be performed.

As a technology for realizing the speech dialog in a network type configuration, a dialog management system technology using a three-tier structure including VoiceXML is known. More specifically, the system is comprised of three tiers, i.e, ScenarioXML in which transition of dialog tasks or the like is described, DialogXML in which dialog sequences of individual tasks are described, and dialog description language VoiceXML in a speech dialog system (for example, Japanese Patent Application Laid-Open Publication No. 2003-316385, and “Development of Speech Dialog Management System CAMMIA” written by Nobuo Hataoka, et al., reference: collected papers of Acoustical Society of Japan 1-6-21, September, 2003). However, although it is possible to cope with the transition of the application in this publicly known example, since management of dialog with the user and access to application task data on the server side are executed by the same dialog management processing unit, detailed management about the access management to the server side cannot be performed. Furthermore, the response to different interfaces and data formats for each task is difficult. In addition, since the configuration of this technology always requires communications between the terminal and the server, unnecessarily high communication cost is required.

On the other hand, there is also a system in which a series of dialog sequences are collected as dialog tasks and the dialog tasks are stored in a tiered structure to provide a dialog task tiered database in order to enhance the transition capability between fields. However, the dialog management and the task management are not separated even in this configuration (for example, Japanese Patent Application Laid-Open Publication No. 2003-5786.).

### SUMMARY OF THE INVENTION

An object of the present invention is to provide a user interface method and a device capable of solving the above-described conventional problems and arbitrarily and efficiently performing the dialog through the speech input in an in-vehicle information service system or the like. Another object of the present invention is to provide a system configuration which can cope with the network connection loss with a center. In addition, the present invention provides a system configuration in which access from a terminal to the center is not always performed but can be performed arbitrarily according to needs.

In order to achieve the above-described objects, in a first aspect of the present invention, a flexible dialog management unit and a task management unit for performing application management are separated from each other as a configuration of a terminal side. In a second aspect, the configuration comprising a four-tier structure of a user interface, dialog management, task management, and applications is provided. Moreover, in a third aspect, means for fetching application information from the center not constantly but according to needs is provided.

The means of the first, second and third aspects are operated so that speech input from the terminal can be arbitrarily inputted in accordance with the arbitrary dialog sequences.

According to the present invention, an effect that speech input from the terminal can be arbitrarily inputted in accordance with the arbitrary dialog sequences can be achieved. In addition, various in-vehicle information services such as traffic conditions, travel information, availability of facilities and the like, and music distribution can be usably and efficiently received from a car at low cost. Further, a system which is strong to the network connection loss with the center can be established, and the communication cost can be reduced.

### BRIEF DESCRIPTIONS OF THE DRAWINGS

FIG. 1 is a diagram of a system configuration showing the fundamental configuration of the present invention;

FIG. 2 is a diagram showing a structure of dialog management unit comprising a three-tier structure;

FIG. 3A and FIG. 3B are diagrams showing an embodiment of ScenarioXML;

FIG. 4 is a diagram showing an embodiment of DialogXML;

FIG. 5 is a diagram showing an example of phrases in a dialog sequence using VoiceXML;

FIG. 6 is a diagram showing processes of a task management unit;

FIG. 7 is a diagram showing system architecture;

FIG. 8 is a diagram showing an example of a flow of speech dialog which is enabled by the present invention;

FIG. 9 is a diagram showing a configuration of an in-vehicle information service system utilizing a speech interface; and

FIG. 10 is a diagram showing a system configuration including a VoiceXML gateway.

### DESCRIPTIONS OF THE PREFERRED EMBODIMENTS

Hereinafter, embodiments of the present invention will be described in detail.

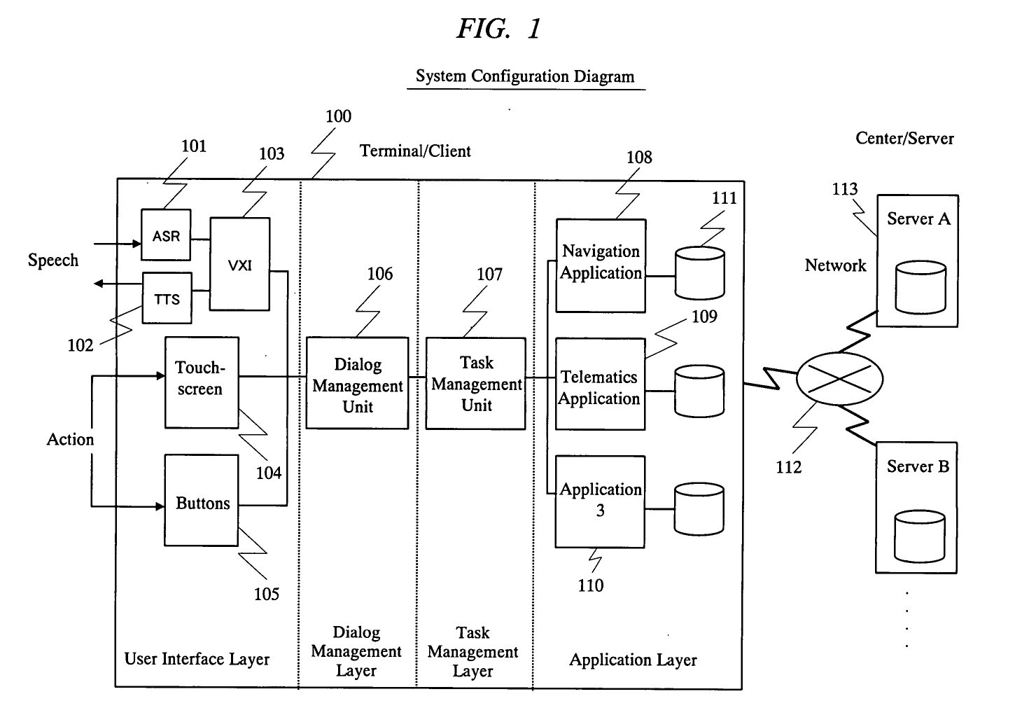

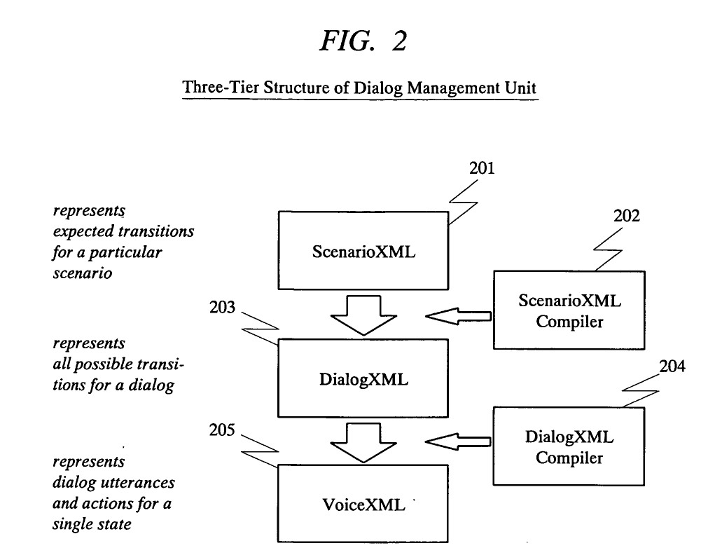

FIG. 1 is a diagram showing a system configuration which is the fundamental of the present invention. In the system configuration of Japanese Patent Application Laid-Open publication No. 2003-316385, all responses relating to dialog management and application tasks are handled in a process of the dialog management. On the other hand, in the system configuration of the present invention, a dialog management unit and a task management unit are separated from each other and cooperate with each other. The input from a user is made by speech or actions such as touching and button operations, i.e., the so-called multimodal input can be performed. This configuration is expected to be used for the interfaces in the in-vehicle information service. A terminal 100 is composed of four tiers, i.e., comprises a user interface layer, a dialog management layer, a task management layer, and an application layer. Hereinafter, the processes in the terminal 100 will be described in detail. Upon speech input from a user, a speech recognition process is executed at an automatic speech recognition (ASR) unit 101, the recognition result is inputted to the dialog management unit 106 via a VoiceXML interpreter (VXI) 103, and the dialog processing is executed based on a dialog scenario that is described in a VoiceXML format. The dialog output from the terminal is carried out by the speech output to the user from a text-to-speech (TTS) synthesis processing unit 102 via the VXI 103. The input from the user may be actions such as touching the touchscreen 104 and pushing the buttons 105. The dialog management unit 106 responds to the dialog through speech with the user or to the actions. More specifically, a dialog scenario is determined according to an application task, and the dialog management is performed according to the scenario. The dialog scenario has a configuration described later with reference to FIG. 2 to FIG. 5. When the task management unit receives the information from the dialog management unit and task transition occurs, the task management unit accesses the application task, reads the dialog scenario and data relevant to the task, and transfers them to the dialog management unit in the VoiceXML format, thereby responding to the dialog of the user.

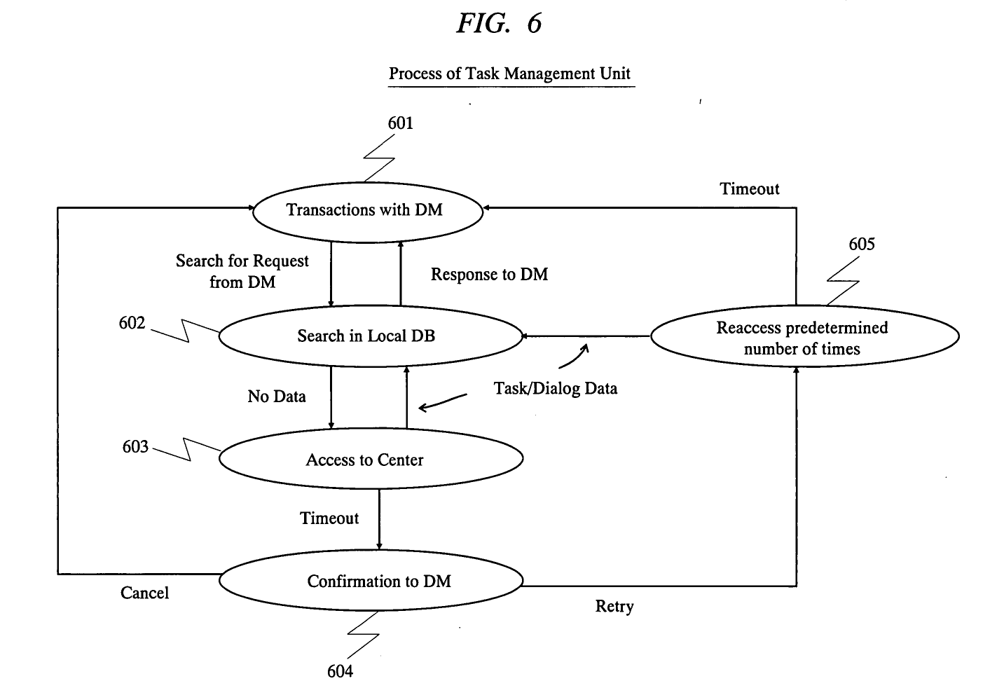

Although processes of the task management will be described in detail later with reference to FIG. 6, the databases have the data contents and data structures depending on the applications to be employed. For example, in the application to a navigation system, the map data and traffic information of the area around the driving area are provided. Every time the driving area shifts to another one, the previous data is deleted, and new map data and traffic information are downloaded from the center and stored in a local DB 111 of the terminal. At this time, information such as the updated time and the number of uses is also stored as accompanying information at the same time.

In the example of FIG. 1, a navigation application 108, telematics application 109, and other application 110 are set as the application layer. The data necessary for the respective applications is stored in the terminal side as local data 111. In accordance with needs, through the access to respective task servers 113 via a network 112, the data is transferred from the remote databases to the local databases and stored therein. The server access from the task management unit via the network is performed in accordance with needs, and the communication between the terminal and center servers is executed only during the access. As a result of separating the dialog management unit from the task management unit in the above-described manner, the dialog management unit mainly handles the speech dialog with the user and responses to the actions, and the task management unit mainly handles the access of application task data. Therefore, various effects can be expected. The first effect is that the dialog management unit can perform the detailed response to multimodal input/output of the user, and the second effect is that, since the task management unit handles the confirmation of the state of the network communication in the structure in which the task management unit is separated from the dialog management unit, the system configuration which can cope with network connection loss can be realized. Moreover, the third effect is that the task management unit can perform the detailed responses to various application tasks using different input/output formats. Furthermore, the fourth effect is that the dialog management unit comprises three tiers including VoiceXML 205 which can significantly suppress the communication cost by virtue of the configuration in which communication between the terminal and the centers is performed only when needed. With respect to the relation of the three tiers, starting from ScenarioXML 201, DialogXML 203 is automatically generated by a ScenarioXML compiler 202, and VoiceXML 205 is automatically generated by a DialogXML compiler 204. The ScenarioXML in the three-tier structure dialog management unit of Japanese Patent Application Laid-Open Publication No. 2003-316385 has a structure that also performs a part of task management processes of the present invention (for example, access to application databases). However, in the present invention, it is sufficient if the unit has a processing function relating to the dialog task transition. In other words, processes up to change of dialog task transition are managed by the dialog management, and the processes following that, i.e., search, access, and data acquisition of the databases are managed by the task management.

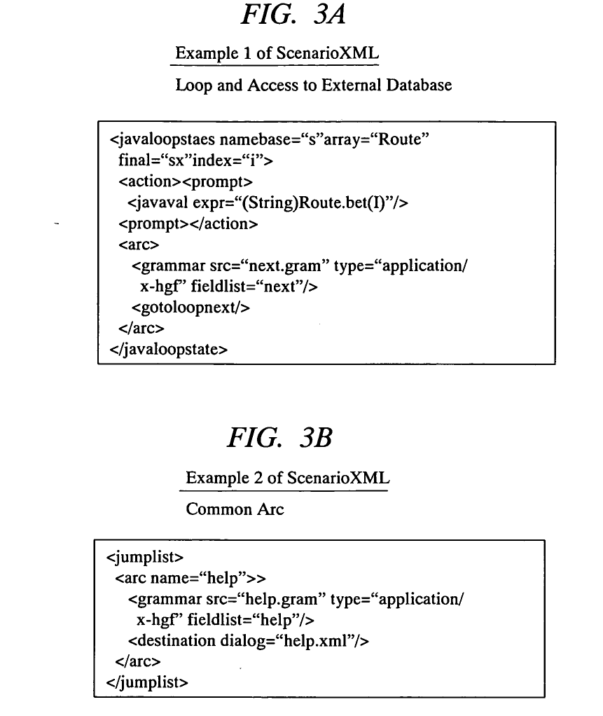

FIG. 3A and FIG. 3B show an embodiment of ScenarioXML. The ScenarioXML is XML-based text information in which the calling of external dictionaries relating to services (referred to as tasks) such as weather forecast and restaurant guide in a case of in-vehicle information service, and relation between the tasks are described. For example, FIG. 3A shows a language structure that enables a loop and access to external databases. FIG. 3B shows a detailed description relating to access to external data such as Speech Recognition Grammar “grammar src” and an example of a common arc. In FIG. 3B, the common arc is a help function and is described between <jumplist> and </jumplist> such that definition can be repeated any number of times.

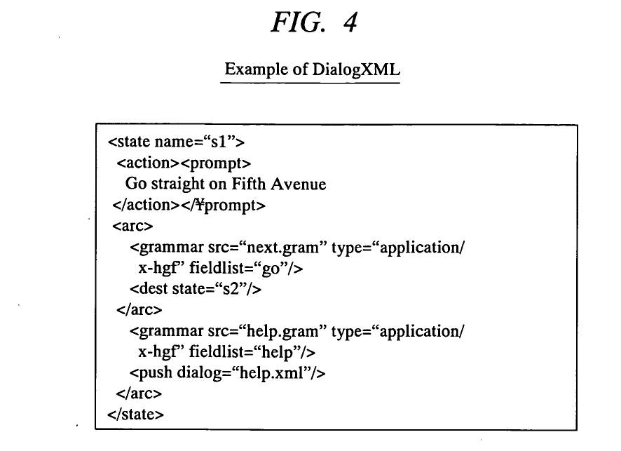

FIG. 4 shows an embodiment of DialogXML in the dialog management method with the three-tier structure. In this example, “Go straight on Fifth Avenue” which is a specific prompt from a route guidance system is described, and Speech Recognition Grammar “grammar src=“next.gram”type” for recognizing an utterance of the user corresponding thereto is described. As described above, DialogXML is a text describing the specific contents of a dialog in a task. When creating it, an actual dialog corpus has to be collected and various phrases have to be noted so as to respond to actual speech input.

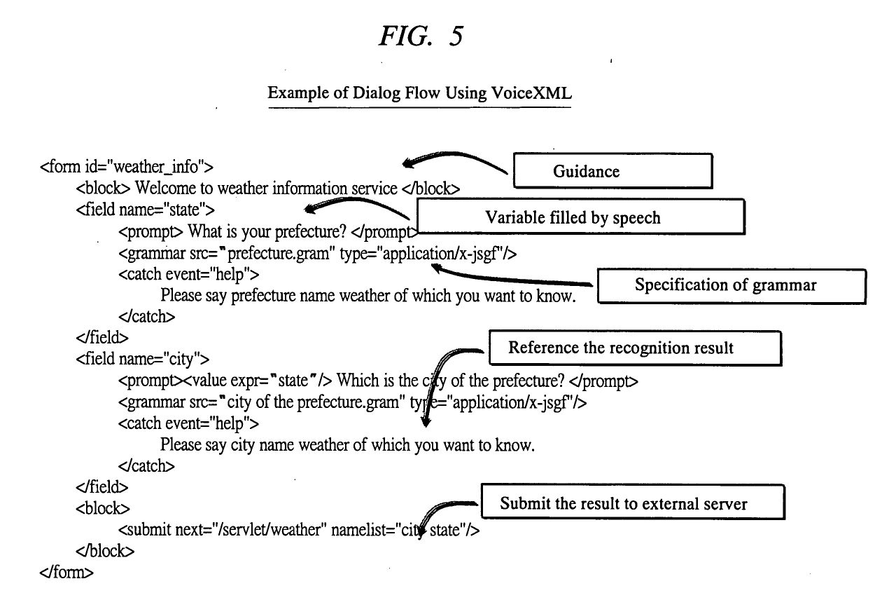

FIG. 5 shows an example of VoiceXML in the dialog management method with the three-tier structure. VoiceXML is a speech dialog description language standardized by the W3C (World Wide Web Consortium), and FIG. 5 shows specific phrases in a dialog flow of a weather forecast guidance task. In this case, by inputting a prefecture name and a place name, the weather forecast of the place is obtained. Starting from a prompt “Welcome to weather information service.” from a system, the user inputs a prefecture name and a place name by speech, thereby obtaining the weather information of the place that the user wants to know. VoiceXML that is executable in the system is automatically generated by compiling DialogXML.

FIG. 6 is a diagram showing details of the processes of the task management unit. In transactions 601 with the dialog management unit (DM), a request is given to the task management unit from the DM when task transition occurs, and local database search 602 is performed for searching required data (task, dialog data). Task transition is determined, for example, when keywords set for the respective tasks in advance are inputted or operated by speech or the actions inputted by the user. If the desired data is present in the local database, a process for transferring the data to the DM is executed through the transactions 601 with the DM. On the other hand, if the required data is not present in the local database, access 603 to the center server is executed via the network. When data is transferred from the center, the data (task, dialog data) is stored in the local database, and the contents thereof are transferred to the DM. When the time of communication with the center is over, determination about the following processes is confirmed (604) from the task management unit to the dialog management unit. If they are cancelled, it returns to a waiting state of the transactions with the dialog management unit, which is the initial state. On the other hand, if the retry is instructed from the dialog management unit, reaccess 605 to the center is executed up to a predetermined number of times. If the data can be acquired as a result of the reaccess, the data storage to the local database and the data transfer to the dialog management unit are performed. The cases other than this are considered as timeout, and it returns to the initial state. The dialog management unit arbitrarily announces to the user that the information is being searched and is in a waiting state while the processes of the task management unit are being performed and the required information is being obtained.

By performing the above-described processes, even when the network communication is interrupted/lost, the reaccess to the center can be performed, and the required data can be obtained.

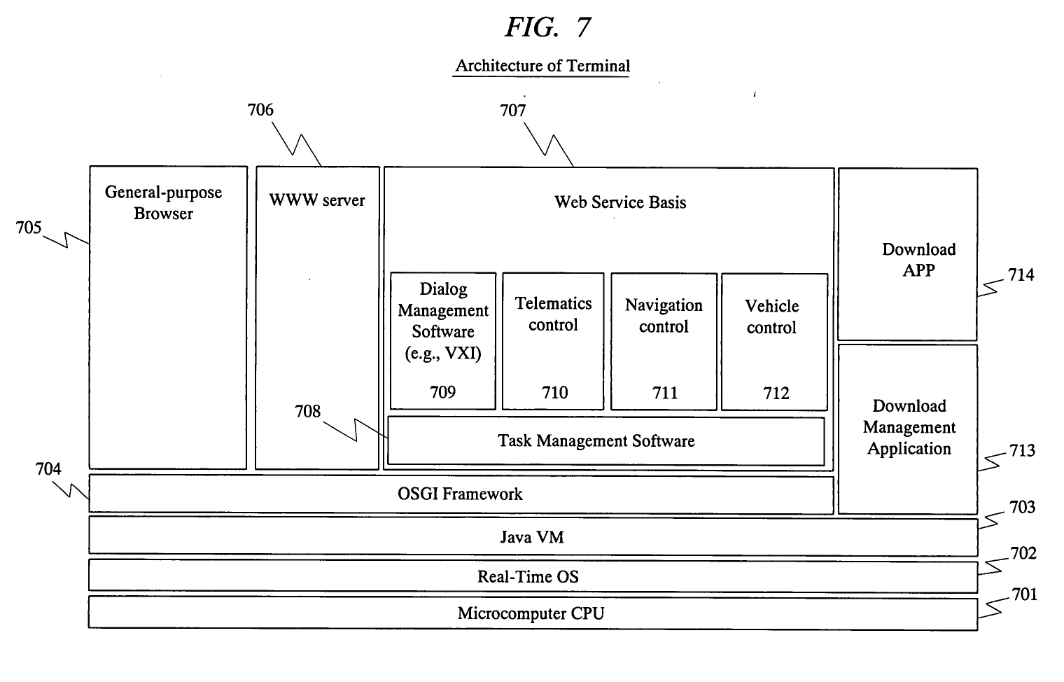

FIG. 7 is a diagram showing an embodiment of the architecture of the terminal having a download function that is realized by the present invention. The basic platform comprises a CPU 701 such as a microcomputer, a real-time OS 702, Java (registered trademark) VM 703, an OSGI (Open Service Gateway Initiative) framework 704, a general-purpose browser 705 in the terminal, and WWW server access software 706. As a part relating to the present invention, task management software 708 and various types of application software are composed in a manner depending on a WWW server access basis 707. As the various applications, dialog management software 709 including VXI, telematics control 710, navigation control 711, and vehicle control 712 are provided. As the function to access the center and download the data, a download management application 713 and a download APP (Application Program Package) 714 are provided. With respect to the relation to FIG. 1, the dialog management software 709 corresponds to the user interface layer and the dialog management layer, the task management software 708 corresponds to the task management layer, and the telematics control 710 and the navigation control 711 correspond to the application layer.

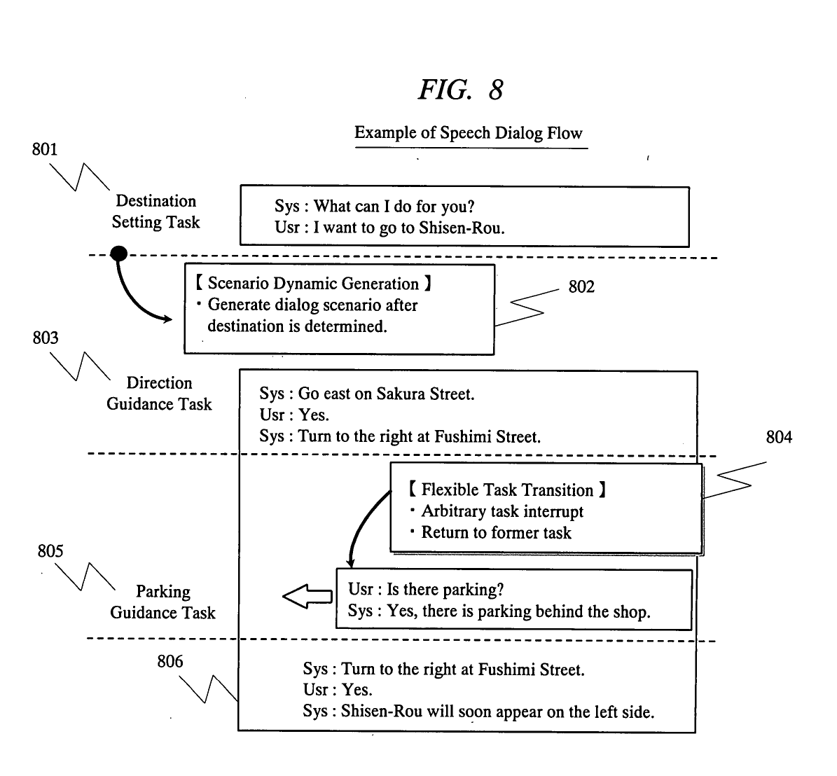

FIG. 8 shows an embodiment of a specific speech dialog scenario in which VoiceXML automatically generated by performing the processes in the system configuration of FIG. 1 is executed. When the service is in operation, in accordance with this speech dialog scenario, the system obtains the information for starting a system operation from the user. Also, in a case of car navigation, first, a normal destination setting task 801 is started. In FIG. 8, when the user inputs “I want to go to Shisen-Rou” in response to a prompt “What can I do for you?” which is a request from the system, a destination is determined. As a result, a dialog scenario to the destination is dynamically set (802), and a direction guidance task 803 is executed. Moreover, in this embodiment, the system performs a flexible task transition process 804 in response to an inquiry “Is there any parking lot?” from the user, and the task is changed to a parking guidance task 805 to output the guidance indicating whether there is parking or not. Then, the system returns to the former direction guidance task 806, and continues guiding directions to the user. An object of the present invention is to realize the guidance service by creating the above-described dialog sequence in advance.

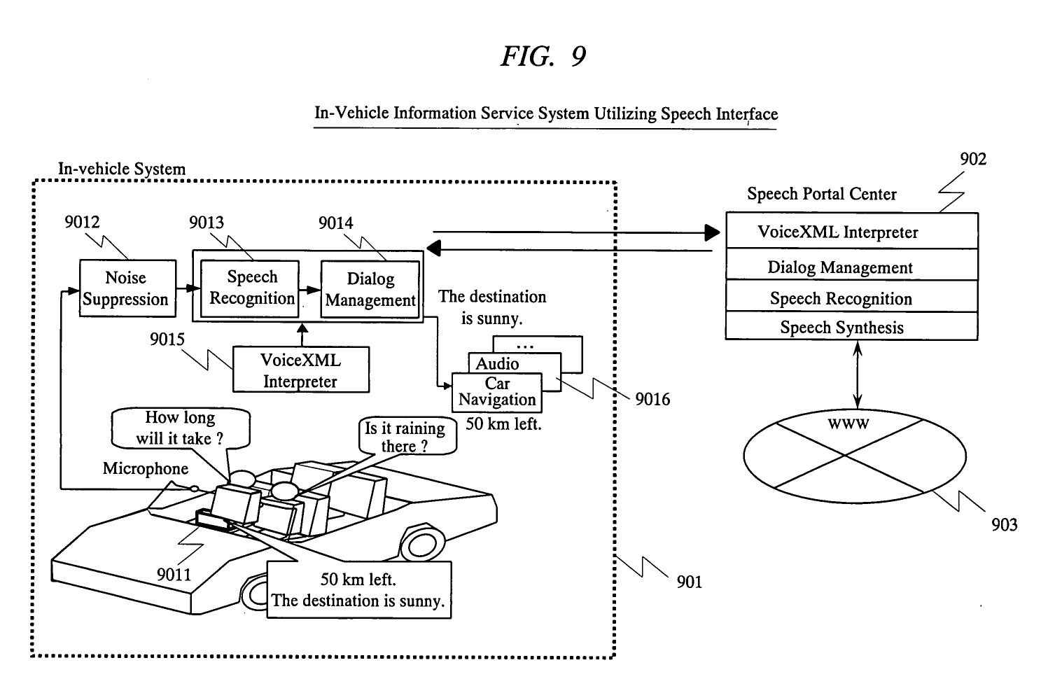

A specific configuration of an in-vehicle information service system utilizing a speech interface is shown in FIG. 9. Service contents are route guidance and weather forecast service. The information about distance to the destination and weather at the destination is obtained by accessing a server on the center side from an in-vehicle system 901 by using a speech interface of an in-vehicle terminal 9011. A speech recognition unit 9013 and a dialog management unit 9014 for realizing the speech interface are sometimes provided in both the in-vehicle terminal side and the speech portal side, and provide necessary information to a driver who is the user through efficient cooperation. A preprocessing 9012 for suppressing the noise is provided in many cases so as to make the system tolerable for the in-vehicle use at a step before the speech recognition. Furthermore, a VoiceXML interpreter 9015 is also provided in both the in-vehicle side and the speech portal center side. In this illustrated example, the configuration of the speech portal center 902 includes at least the dialog management unit, the speech recognition unit, and speech synthesis unit, and the dialog sequence is realized by a VoiceXML description language. In the cooperation between a speech processing unit of the in-vehicle terminal and the speech processing unit of the speech portal, the processing of service requests that do not require connection to the network, for example, operation of an in-vehicle audio device 9016 is completed only by the in-vehicle terminal, and the information, for example, ever changing road information is obtained via a network 903 such as WWW by connecting to the center. At this time, from the viewpoint of the reduction of communication cost and avoiding distortion in sound through a communication line, it is important to share the speech recognition processes, the dialog management processes or the like in cooperation with, for example, a speech portal gateway.

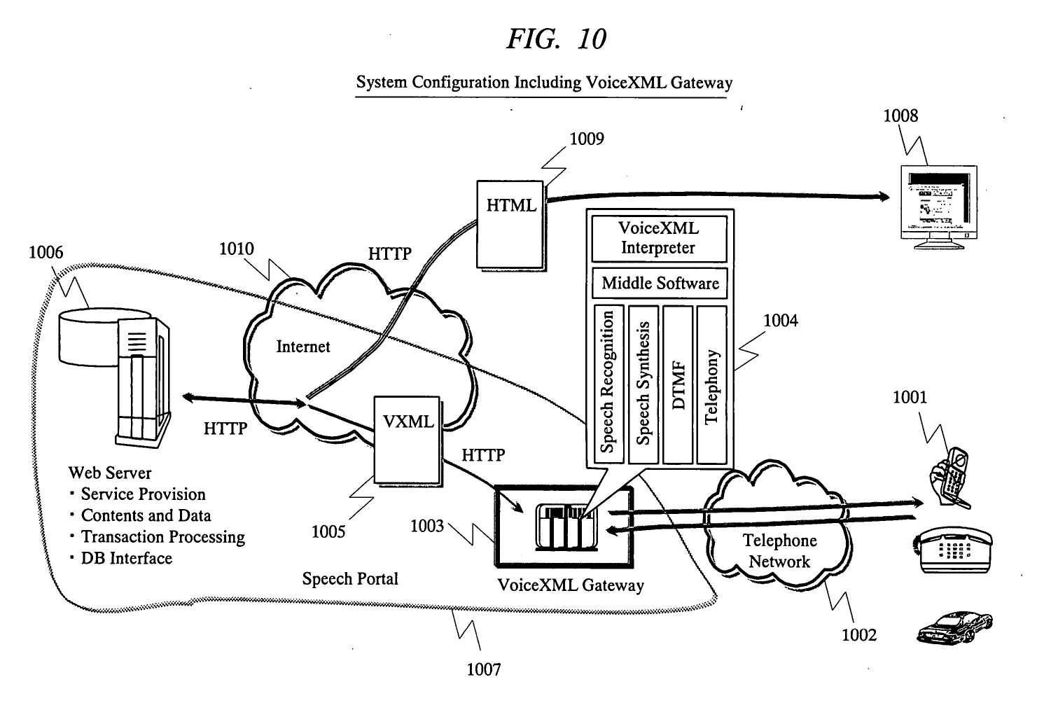

FIG. 10 shows a general system configuration of speech service utilizing VoiceXML which is realized by the present invention. This illustrated system configuration includes a VoiceXML gateway which is realized by, for example, a VoiceXML interpreter. Conventionally, as the configuration for receiving the service by connecting to a network such as the Internet, a method using a personal computer (PC) 1008 as the input has been a mainstream. In this case, the web pages about the contents which are connected to the Internet 1010 are described in a normal HTML 1009. However, when input means such as a cellular phone 1001 or the like is utilized, access to web pages 1005 and 1006 which are described in VoiceXML is made via a VoiceXML gateway (or a speech portal gateway) 1003 by utilizing a telephone network 1002. The VoiceXML gateway 1003 comprises a processing module 1004 of a VoiceXML interpreter, speech recognition, speech synthesis, DTMF, etc.

1. A speech information service system connected to a terminal having at least a speech input function and to a service center by a network, said speech information service system comprising:
as a terminal configuration, a dialog management unit for managing a dialog processing state between a user and the terminal; and a task management unit for managing a service task state as a terminal configuration, which are separated from each other.

2. The speech information service system according to claim 1,
wherein the terminal configuration comprises at least four tiers of a user interface layer, a dialog management layer which is mainly composed of the dialog management unit, a task management layer which is mainly composed of the task management unit, and an application layer.

3. The speech information service system according to claim 1,
wherein the dialog management unit is composed of a three-tier structure of ScenarioXML, DialogXML, and VoiceXML.

4. The speech information service system according to claim 2,
wherein the dialog management unit is composed of a three-tier structure of ScenarioXML, DialogXML, and VoiceXML.

5. The speech information service system according to claim 1,
wherein the task management unit has means for detecting a dialog state and a task change state based on information from the dialog management unit, and managing interfaces corresponding to various application tasks and a download state of task information from the service center.

6. The speech information service system according to claim 2,
wherein the task management unit has means for detecting a dialog state and a task change state based on information from the dialog management unit, and managing interfaces corresponding to various application tasks and a download state of task information from the service center.

7. The speech information service system according to claim 1,
wherein, when task transition occurs in said dialog management unit, the transition is notified to said task management unit,
said task management unit searches the data relating to the notified task in a local database,
if the data is found, the found data is transmitted to said dialog management unit, and
if the data is not found, the data relating to said task is obtained via the network.

8. A speech information service terminal comprising:
a communication unit connecting to an external service center via a network;
a dialog management unit for managing a dialog processing state with a user;
a task management unit for managing a task state of said dialog; and
a database for recording information required for said dialog,
wherein, when task transition occurs, said dialog management unit notifies the transition to said task management unit,
said task management unit searches the data relating to the notified task in said database,
if the data is found, the task management unit transmits the found data to said dialog management unit, and
if the data is not found, the task management unit obtains the data relating to the task from said external service center via said communication unit.
